(19) United States
(12) Patent Application Publication
(10) Pub. No.: US 2011/0088013 A1
(43) Pub. Date: Apr. 14, 2011

(54) METHOD AND SYSTEM FOR SYNCHRONIZING SOFTWARE MODULES OF A COMPUTER SYSTEM DISTRIBUTED AS A CLUSTER OF SERVERS, APPLICATION TO DATA STORAGE

(75) Inventors: Dominique Vinay, Clamart (FR); Philippe Motet, Igny (FR); Loic Lambert, Le tour du Parc (FR); Soazing David, Plumergat (FR)

(73) Assignee: ACTIVE CIRCLE, Vannes Cedex (FR)

(21) Appl. No.: 12/996,285

(22) PCT Filed: May 22, 2009
(86) PCT No.: PCT/FR2009/050955

§ 371 Date: Dec. 3, 2010

(30) Foreign Application Priority Data
Jun. 6, 2008 (FR) 08/03140

(51) Int. Cl. G06F 9/44

(52) U.S. Cl. 717/122

(57) ABSTRACT

A method for synchronizing software modules of an IT system distributed across plural servers interconnected as a network, each software module being executed on a server of the IT system for management of a set of data elements describing a service, and at least a part of descriptive data elements is replicated on plural software modules. The method includes: execution, on a first software module, of an action acting on a descriptive data element, transmission of a synchronization message identifying the action to all the other software modules of the IT system including a replication of this descriptive data element, and on receipt of this message by any of the software modules concerned, execution of the action identified on this software module so as to act on the replication of the descriptive data element located on this software module.

The present invention concerns a method and a system for synchronising software modules of an IT system distributed across several servers interconnected as a network. It also concerns the application of such a method to a data storage service and a computer program for the implementation of this method.

The invention applies more specifically to an IT system in which each software module is executed on a server of the IT system for the management of a set of data elements describing a service, where at least a part of the descriptive data is replicated on several software modules.

The service provided by the IT system is, for example, a data storage service distributed between the servers interconnected as a network, where each server is linked to hard disk or magnetic tape storage peripherals. In this case, the descriptive data contains, for example, data describing users of the storage service, data describing the infrastructure and operation of the IT system for the supply of the service, and data describing the stored data and the way in which it is stored.

The service supplied by the IT system can also be a service for transmission of information data, for data processing, for computation, for transaction, or for a combination of these services. In each case, the descriptive data is adapted specifically to the supplied service.

The servers of the IT system on which the software modules are executed are generally interconnected by at least one network of the LAN type (Local Area Network) and/or WAN type (Wide Area Network). This set of servers interconnected as a network can notably be called a “cluster of servers”, the software modules then generally being called the “nodes” of the cluster.

In such an architecture, a particular server or software module is, in principle, dedicated to managing all the software modules, notably for the synchronisation of the replicated descriptive data. Moreover, in this type of application, the descriptive data and its possible modifications can be defined in such a way as to optimise the synchronisation by making the modifications commutative as far as possible: higher number of separate fields in a given descriptive data element, modifications defined incrementally in order to prevent conflicts, definition of “a priori” rules for managing potential conflicts, etc. In light of the foregoing, even if the synchronisation of the descriptive data is not as complex in the envisaged case as in an application for collaborative editing of data, in which several agents act on data elements the modifications of which are not generally commutative, problems appear when the server or the software module dedicated to managing the system is defective.

For example, in the patent application published as number FR 2 851 709, it is provided that a service is able to be supplied, via a communication network, to the user through a main server associated with a database. Auxiliary servers connected to this main server are also provided in the communication network in order to make this service more rapidly accessible to the user. But they must then be synchronised with the main server, notably with its database. To accomplish this synchronisation of the main server with the auxiliary servers, the communication network is equipped with specific means for synchronisation, for example implemented in resource servers. It therefore appears that certain elements of the communication network, the main server and the resource servers, have a very particular role, and a fault in them may have immediate consequences for the quality of service provided.

In the patent application published as number US 2007/0233900, a system involving a cluster of data processors provides that several data processors may copy locally a given data element originating from common means of storage. To manage the synchronisation of all the copies of a given data element, a system of pairing between the data processors provides the update of the joint means of storage whenever a data element copied locally is modified by a data processor, such that the other data processors are able to update their locally copied data, with reference to the common means of storage. Here too, the architecture of the system anticipates a particular role for the pairing system and the common means of storage.

It may thus be desired to establish a method for synchronising software modules of an IT system distributed across several servers interconnected as a network, which enables the abovementioned problems and constraints to be overcome.

The purpose of the invention is therefore a method for synchronising the software modules of an IT system distributed across several servers interconnected as a network, where each software module is executed on a server of the IT system for the management of a set of data elements describing a service, in which at least a part of the descriptive data is replicated on multiple software modules, characterised in that it comprises, at each execution, in any one of the software modules, called the first software module, of an action acting on a descriptive data element managed by this first software module, the following steps:
transmission by the first software module of a synchronisation message identifying the action to all the other software modules of the IT system containing a replication of this descriptive data element,
on receipt of this message by any of the software modules concerned, execution of the identified action on this software module so as to act on the replication of the descriptive data element located on this software module.

Thus, the consequence of the execution of an action on a first software module of the IT system is, through the transmission of a message identifying this action, the execution of this same action on all the other software modules managing a replication of the descriptive data element concerned by this action. Accordingly, whatever the software module on which the action is first executed, this module acts as a synchronisation manager, and the result is the same: everything occurs as though the action were executed on all the software modules containing the descriptive data element concerned by the action. No software module therefore plays a privileged or particular role from the standpoint of management of the service's descriptive data elements, making the complete IT system less vulnerable to breaks in service in the event of a fault of a software module or a server.

Optionally, since execution of the action on the first software module causes the update of the version index and of a signature of the descriptive data element concerned, execution of the action on any of the software modules containing a replication of this descriptive data element causes the same update of version index and of signature of the replication of the descriptive data element concerned.

It is thus possible to verify at all times that the descriptive data replications are indeed synchronised.

Optionally, the update of the signature of the descriptive data element concerned is designed so as to be incremental and commutative. This enables any conflicts of overlapping actions to be managed. Indeed, although, as was stipulated above, the actions themselves can be commutative or their conflicts managed by a priori rules, it is advantageous that the signatures should also be defined so as to make their updates commutative.

Optionally, the signature increment is the result of a random data generation.

Optionally, since the set of descriptive data elements contains a tree structure in which each descriptive data element is either a node comprising at least one child element, or a terminating leaf, each node in the tree structure is associated with a global signature corresponding to the sum of the signatures of the descriptive data elements located downstream from this node in the tree structure. This notably enables all the descriptive data elements to be traversed rapidly in order to check the synchronisation of two replications of this set.

Optionally, a method for synchronising software modules of an IT system distributed across a cluster of servers according to the invention can also comprise the following steps:
during the bringing into operation of a software module containing a part of the descriptive data elements, extraction of a state of the replications of this part of the descriptive data elements on at least one other software module, and saving of the software module as a potential receiver of at least one synchronisation message identifying an action on at least one replication of its descriptive data elements located on another software module,
synchronisation of the software module's descriptive data elements with the descriptive data elements of the other software module and, during this synchronisation, queuing of any synchronisation messages which may be received,
when the synchronisation has terminated, the queue is processed.

The purpose of the invention is also an application of a method of synchronisation of software modules as described above to an IT system distributed across a cluster of servers for the supply of a data storage service distributed between storage peripherals, each of which is linked to a server in the IT system.

Optionally, the descriptive data elements contain at least one of the elements of the set consisting of data describing the general infrastructure and the general operation of the IT system, of data describing the users of the data storage service and access rights, of data describing the structure or method of storage and the replication of the stored data, and of data describing the local infrastructure and the local operation of a server or software module of the IT system.

The purpose of the invention is also a computer program downloadable from a communication network and/or recorded on a medium readable by computer and/or executable by a processor, characterised in that it comprises program code instructions for the execution of the steps of a method for synchronising software modules of an IT system distributed across several servers interconnected as a network, as defined above, when the said program is executed on a computer.

Finally, the purpose of the invention is also a system for synchronising software modules of an IT system, comprising several servers interconnected as a network, where each software module is executed on a server in the IT system for the management of a set of data elements describing a service, in which at least a part of the descriptive data is replicated on multiple software modules, characterised in that it comprises, in each software module managing the descriptive data:
means for transmitting a synchronisation message, identifying an action acting on a descriptive data element, to all the other software modules in the IT system containing a replication of this descriptive data element, whenever such an action is executed on this software module, and
means for executing an action acting on a descriptive data element and identified in a synchronisation message, so as to act on the replication of the descriptive data element located on this software module, in response to the reception by this software module of the synchronisation message.

The invention will be better understood by means of the following description, given solely as an example, and made in reference to the appended illustrations, in which:

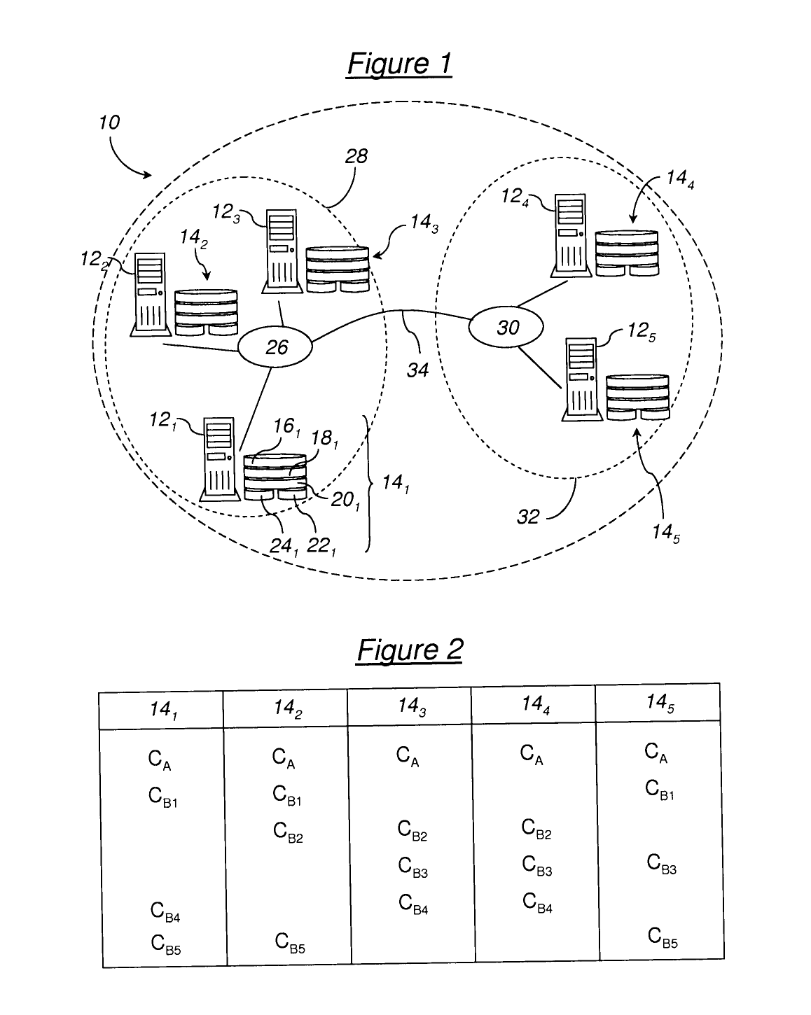

FIG. 1 represents diagrammatically the general structure of an IT system for data storage distributed across several servers interconnected as a network,

FIG. 2 illustrates an example of distribution of descriptive data in the IT system of FIG. 1,

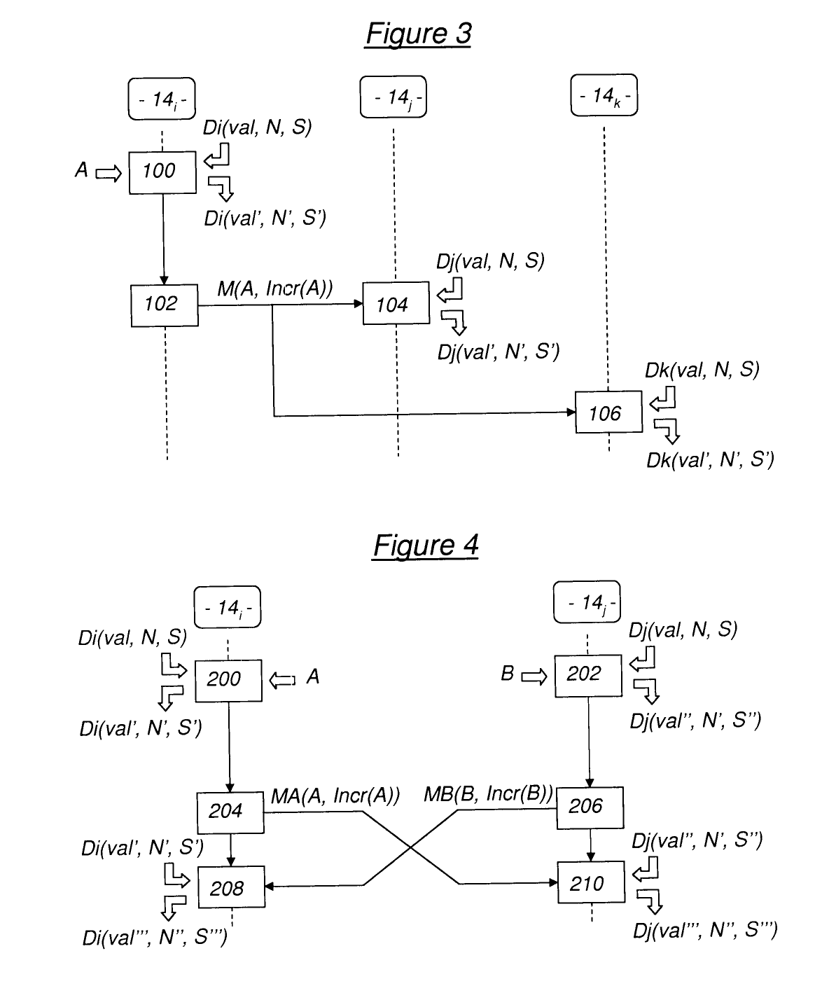

FIG. 3 illustrates the successive steps of a method for synchronisation according to an embodiment of the invention,

FIG. 4 illustrates a particular case of execution of the method of FIG. 3, in which a possible conflict of executions of overlapping actions is resolved,

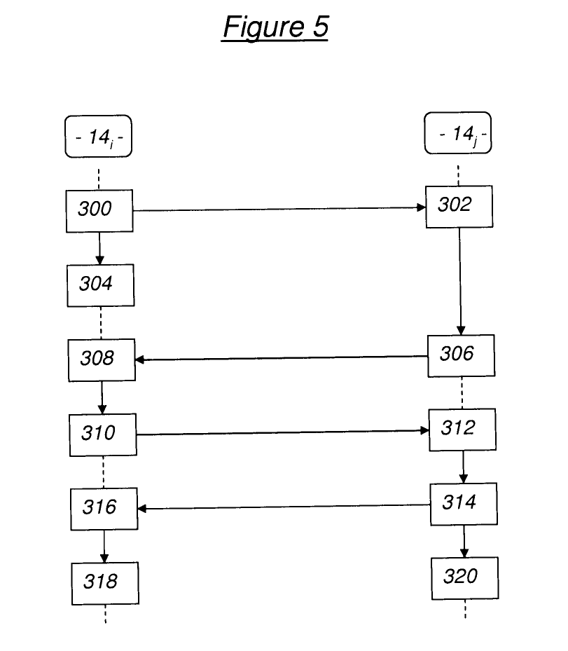

FIG. 5 partially illustrates the successive steps of a method for synchronisation according to another embodiment of the invention.

IT system 10 represented in FIG. 1 comprises several servers 12₁, 12₂, 12₃, 12₄ and 12₅, distributed across several domains. Each server is of the traditional type and will not be described in detail. Conversely, on each server 12₁, 12₂, 12₃, 12₄ and 12₅ is installed at least one specific software and hardware module 14₁, 14₂, 14₃, 14₄ and 14₅, for management of a service, for example a data storage service.

Five servers and two domains are represented in FIG. 1 purely for the sake of illustration, but any other structure of IT system distributed across several servers interconnected as a network may be suitable for implementation of a method of synchronisation according to the invention. Also for the sake of simplification, one software and hardware module for each server is represented, such that the modules and their respective servers may be taken together in the remainder of the description, although there is no obligation for them to be taken together in a more general implementation of the invention.

The software and hardware module 14₁ of server 12₁ is described in detail in FIG. 1. It comprises a first software layer 16₁ consisting of an operating system of server 12₁. It comprises a second software layer 18₁ for managing data describing the data storage service provided by IT system 10. It comprises a third software and hardware layer 20₁ fulfilling at least two functions: a first storage function, on an internal hard disk of server 12₁, of data describing the storage service, and a second function, also on this hard disk, providing a cache memory of data stored on storage peripherals of server 12₁. Finally, it comprises a fourth software and hardware layer 22₁, 24₁ of data warehouses, comprising at least one data warehouse on hard disk 22₁ and/or at least one data warehouse on magnetic tapes 24₁. In the remainder of the description a data warehouse designates a virtual space for data storage consisting of one or more disk partitions, or one or more magnetic tapes, from among the storage peripherals of the server with which it is associated.

The software and hardware modules 14₂, 14₃, 14₄ and 14₅ of servers 12₂, 12₃, 12₄ and 12₅ will not be described in detail since they are similar to software and hardware module 14₁.

In the example illustrated by FIG. 1, servers 12₁, 12₂ and 12₃ are mutually interconnected by a first network 26 of the LAN type to create a first subsystem or domain 28. This first domain 28 is, for example, a localised geographical organisation, such as a geographical site, a building or a computer room. Servers 12₄ and 12₅ are mutually interconnected by a second network 30 of the LAN type, creating a second subsystem or domain 32. This second domain 28 is also, for example, another localised geographical organisation, such as a geographical site, a building or a computer room. These two domains are connected to one another by a network of the WAN type 34, such as the Internet network.

Thus, this IT system as a cluster of servers distributed over several geographical sites enables a store of data elements to be envisaged which is particularly secure since these elements can be replicated on software and hardware modules located in different geographical sites.

The storage service provided by this IT system 10 and the data elements actually stored are advantageously completely defined and described by a set of descriptive data elements the general principles of which will be described with reference to FIG. 2. In this manner, management of these descriptive data elements by software layer 18ᵢ of any of the software and hardware modules 14ᵢ provides management of the storage service of the IT system 10.

The descriptive data elements are, for example, grouped into several sets structured according to their nature, and possibly interconnected. A structured set, which will be called a “catalogue” in the remainder of the description, may take the form of a tree structure of directories, themselves containing other directories and/or descriptive data files. The representation of the descriptive data elements according to a tree structure of directories and files has the advantage that it is simple and therefore economical to design and manage. In addition, this representation is often sufficient for the service concerned. It is also possible, for more complex applications, to represent and manage the descriptive data elements as relational databases.

A catalogue of descriptive data elements may be global, i.e. relate to descriptive data elements useful to the entire IT system 10, or alternatively local, i.e. relate to specific descriptive data elements or to one or more service management software and hardware module(s) 14₁, 14₂, 14₃, 14₄ or 14₅. Advantageously, and in accordance with the invention, each catalogue is replicated on several servers or software and hardware modules. When it is global it is preferably replicated on all the software and hardware modules. When it is local it is replicated on a predetermined number of software and hardware modules, including at least the one or those to which it relates.

As an example, FIG. 2 represents a possible distribution of descriptive data catalogues between the five software and hardware modules 14₁, 14₂, 14₃, 14₄ and 14₅.

A first global catalogue C_{A} is replicated on the five software and hardware modules 14₁, 14₂, 14₃, 14₄ and 14₅. It contains, for example, data describing the general infrastructure and the general operation of the IT system 10 supplying the service, notably the tree structure of the domains and of the software and hardware modules of IT system 10. It may also contain data describing potential users of the data storage service and their access rights, for example previously registered users, together with shared areas, and the structure or method of storage and replication of stored data.

Other catalogues are local, such as, for example, catalogue C_{B1}, containing descriptive data specific to the software and hardware module 14₁ such as the local infrastructure and the local operation of server 12₁ and of its storage peripherals, or the organisation into warehouses of software and hardware module 14₁. This catalogue is replicated three times, one of which on software and hardware module 14₁. To improve the security and robustness of IT system 10, catalogue C_{B1} may be replicated in several different domains. In this case, where the complete system contains two domains 28 and 32, the catalogue C_{B1} is, for example, backed up on modules 14₁ and 14₂ of domain 28 and on module 14₅ of domain 32.

Similarly, the software and hardware modules 14₂, 14₃, 14₄ and 14₅ are associated with respective local catalogues C_{B2}, C_{B3}, C_{B4} and C_{B5}. For example, catalogue C_{B2} is backed up on modules 14₂ and 14₃ of domain 28 and on module 14₄ of domain 32; catalogue C_{B3} is backed up on module 14₃ of domain 28 and on modules 14₄ and 14₅ of domain 32; catalogue C_{B4} is backed up on module 14₄ of domain 32 and on modules 14₁ and 14₃ of domain 28; and catalogue C_{B5} is backed up on module 14₅ of domain 32 and on modules 14₁ and 14₂ of domain 28.

The abovementioned list of catalogues of descriptive data is not exhaustive, and is given only as an example, as is the number of replications of each catalogue.

By this replication of catalogues, in this case on at least three software and hardware modules for each catalogue, it is observed that even if one software and hardware module, or two, is/are out of service, the overall system is capable of accessing all the descriptive data, such that management of the data storage service is not necessarily interrupted. In practice this maintained continuity of service is effective from the time the catalogues are synchronised.

To accomplish this the software layer of each software and hardware module of IT system 10 comprises:
means for transmitting a synchronisation message, identifying an action acting on a descriptive data element, to all the other software modules in the IT system containing a replication of this descriptive data element, following execution of this action on this software module, and
means for executing an action acting on a descriptive data element and identified in a synchronisation message, so as to act on the replication of the descriptive data element located on this software module, in response to the reception of the synchronisation message.

A particularly advantageous method for synchronising descriptive data catalogues will now be described in detail, in accordance with an embodiment of the invention.

Firstly, it should be stipulated that a synchronisation of a catalogue is required whenever a replication of a descriptive data element of this catalogue is modified on any software and hardware module of the IT system. A modification of a descriptive data element may be completely defined by a determined action A on this descriptive data element. For example, a modification of a descriptive data element concerning a user may be defined by an action on their rights of access to the IT system 10 chosen from among a set of rights containing system administrator rights, data administrator rights, operator rights, and simple user rights. In this case action A precisely identifies the descriptive data element to which it applies and the new value of this descriptive data element (in this instance: system administrator, data administrator, operator or simple user). Action A is identified by a single universal identifier and may be backed up, such that the current state of a descriptive data element may be recovered if the initial state of this descriptive data element and the series of actions operated on it since its creation are known.

As previously stated, the descriptive data and/or the modification actions which can be executed on this data are advantageously defined such that the actions are commutative as far as possible, i.e. that two actions give an identical result, whatever the order in which they are executed. For example, by increasing the number of modifiable fields in a given descriptive data element the number of potential conflicts is limited statistically, since the probability that two actions may be executed simultaneously on a given data field is reduced. For example, also, by defining fields of the meter type and possible incremental modifications in relation to these fields, the corresponding actions are made commutative in the event of a conflict. Finally, when a descriptive data element field and the corresponding actions cannot be defined such that the latter are commutative (setting of the “colour” type and action of the “change of colour” type, for example), it is also possible to define “a priori” rules for managing conflicts (priorities, predefined decision-making criteria, etc.), to generate alarms in the event of the conflict for a “manual” management of the conflict, or to block multiple accesses for all actions on these data fields. In any event, it will be noted that this problem of management of potential conflicts between actions executed quasi-simultaneously and relating to a given descriptive data element is different from the problem of synchronisation as such resolved by the invention, even if it is posed in an identical context, and even if it enables this synchronisation to be optimised.

Each local replication of a descriptive data element D is, moreover, associated with a version V which contains a version number N and a signature S. In a preferred embodiment, every creation or deletion modification made by an action A on a replication of the descriptive data element D also modifies its version V as follows:
N←N+1;
S←S+Incr(A), in which Incr(A) is a random value generated on execution of action A on the replication of the descriptive data element concerned.

As illustrated in FIG. 3, during a first step 100, an action A is executed on a replication Di of the descriptive data element D, and this replication Di is stored by server 12ᵢ. Before execution of action A the replication Di of the descriptive data element D has a value val, a version number N and a signature S. After execution of action A, the replication Di of the descriptive data element D has a value val′, a version number N′=N+1 and a signature S′=S+Incr(A).

During the execution of action A, the replication Di of descriptive data element D is protected such that other actions on this replication cannot be executed. Any such other actions are queued in a list established for this purpose and are executed sequentially when the execution of action A has terminated.

During a following step 102, a synchronisation message M is generated by the software and hardware module 14ᵢ. This message M contains the universal identifier of action A, or a complete description of this action A, together with the value of signature increment Incr(A). During this same step, message M is transmitted to the software and hardware modules 14ⱼ and 14ₖ also containing a replication of descriptive data element D, via the transmission network 26, 30, 34.

After this, in a step 104, on receipt of the synchronisation message M, the software and hardware module 14ⱼ executes action A on replication Dj of the descriptive data element D, so as to update its value, its version number and its signature, which then take on the respective values val′, N′ and S′. The version number N is updated by applying the same rule as that applied by the hardware and software module 14ᵢ and the update of the signature is accomplished by means of the transmission of signature increment Incr(A) generated by the hardware and software module 14ᵢ.

Also after this, in a step 106, on receipt of the synchronisation message M, the software and hardware module 14ₖ executes action A on replication Dk of the descriptive data element D, so as to update its value, its version number and its signature, which then take on the respective values val′, N′ and S′.

Using this repeated synchronisation method at each execution of an action on any of the descriptive data elements in the IT system 10, the catalogues replicated on several nodes remain identical, subject to the time required to accomplish the synchronisation.

Other techniques for modification of the version V of a replication of a descriptive data element than the one presented in reference to FIG. 3 may be conceivable as alternatives, but it is advantageous to ensure that the update of signature S is incremental and commutative, which enables overlapping modifications of different replications of a given descriptive data element to be managed, as is illustrated by FIG. 4.

Indeed, during a first step 200, an action A is executed on a first instance of replication Di of the descriptive data element D, and this replication Di is stored by server 12ᵢ. Before execution of action A the replication Di of the descriptive data element D has a value val, a version number N and a signature S. After execution of action A, the replication Di of the descriptive data element D has a value val′, a version number N′=N+1 and a signature S′=S+Incr(A).

Even before the hardware and software module 14ᵢ has had time to send a synchronisation message MA to the other software and hardware modules having a replication of the descriptive data element D, an action B is executed on one of them, hardware and software module 14ⱼ, during a step 202. During this step, action B is executed on a second instance of replication Dj of the descriptive data element D. Before execution of action B the replication Dj of the descriptive data element D has the value val, the version number N and the signature S. After execution of action B, the replication Dj of the descriptive data element D has a value val″, different from val′, the version number N′=N+1 and a signature S″=S+Incr(B), which is different from signature S′.

Thus, on conclusion of steps 200 and 202, although replications Di and Dj have the same version number N′, their signatures and respective values are different. Their versions V′ and V″, identified at once by their version numbers and their signatures, are therefore different.

During a following step 204, the synchronisation message MA is generated by the software and hardware module 14ᵢ. This message MA contains the universal identifier of action A, or a complete description of this action A, together with the value of signature increment Incr(A). During this same step, message MA is notably sent to the hardware and software modules 14ⱼ containing replication Dj.

Similarly, during a following step 206, a synchronisation message MB is generated by the software and hardware module 14ⱼ. This message MB contains the universal identifier of action B, or a complete description of this action B, together with the value of signature increment Incr(B). During this same step, message MB is notably sent to the hardware and software module 14ᵢ containing replication Di.

During a step 208, on receipt of the synchronisation message MB, the software and hardware module 14ᵢ executes action B on replication Di of the descriptive data element D, so as to update its value, its version number and its signature, which then take on the respective values val′″, N″ and S′″. Value val′″ results from action B on val′, i.e. from the combination of the actions A and B on the value val of descriptive data element D. Value N″ is equal to N′+1, i.e. N+2. At the end, the value of S′″ is equal to S′+Incr(B)=S+Incr(A)+Incr(B).

Finally, in a step 210, on receipt of the synchronisation message MA, the software and hardware module 14ⱼ executes action A on replication Dj of the descriptive data element D, so as to update its value, its version number and its signature, which then take on the same respective values val′″, N″ and S′″ as for Di in step 208. Indeed, value val′″ results from action A on val″, i.e. from the combination of actions A and B on the value val of descriptive data element D if it is supposed, as described in detail above, that the commutativity of actions A and B is acquired by definition or by conflict management. Value N″ is equal to N′+1, i.e. N+2. Finally, the value of S′″ is equal to S″+Incr(A)=S+Incr(B)+Incr(A), due to the incremental and commutative property of the update of the signature.

It is therefore observed that on completion of steps 208 and 210 replications Di and Dj are correctly synchronised, and their identical versions prove the identity of their values.

The previously described synchronisation method enables each software and hardware module to be kept up-to-date for the management of the descriptive data elements of the service provided by the IT system 10, provided each software and hardware module is able to receive and process synchronisation messages which are sent to it. Conversely, when a software and hardware module is brought into operation, for example through the addition of a new server or following a local break in service, the described method does not enable any delay incurred relative to the other software and hardware modules in managing the descriptive data to be made up.

It may then be envisaged to implement an embodiment of the invention also resolving this additional problem. Such an embodiment is partially illustrated in FIG. 5. It consists in including specific additional steps for updating a software and hardware module when it is brought into operation within IT system 10. The additional steps are not, of course, executed when this software and hardware module is the first one to be put into a state of operation in the IT system. This embodiment applies when the software and hardware module becomes active in the IT system when other software and hardware modules containing replications of its catalogues are already in an operational and synchronised condition, due to the method described in reference to FIGS. 3 and 4.

According to this embodiment, in a first step 300, during which a software and hardware module 14ᵢ becomes active in the IT system 10, the latter selects a software and hardware module 14ⱼ for synchronisation of one of its catalogues of descriptive data elements. It naturally selects one of the software and hardware modules managing a replication of the catalogue which it wishes to update. When software and hardware module 14ⱼ is selected, during this same step 300, software and hardware module 14ᵢ sends it its identifier together with information concerning the versions of each of the descriptive data elements of its catalogue (i.e. version number and signature).

Subsequently, in a step 302, software and hardware module 14ⱼ establishes a fixed representation of the content of its catalogue and creates a waiting list for the reception of every new synchronisation message concerning this catalogue.

Also following step 300, in a step 304, software and hardware module 14ᵢ is registered as an owner of a replication of the catalogue and as an addressee of any synchronisation messages concerning this catalogue. Also during this step a waiting list is created for the receipt of all new synchronisation messages concerning this catalogue.

Following step 302, in a step 306, software and hardware module 14ⱼ compares the versions of the descriptive data elements of software and hardware module 14ᵢ with its own. This search for differences between two replications of a given catalogue may be facilitated when the catalogue of descriptive data elements is structured as a tree in which the descriptive data elements are either nodes (when they have a direct or indirect filiation relationship with at least one “child” descriptive data element), or leaves (when they are located at the end of the tree in this hierarchical representation). Indeed, in this case, each node in the tree may be associated with a global signature which represents the sum of the signatures of its “child” data elements, i.e. descriptive data elements located downstream from this node in the tree. Thus, the search for differences is accomplished by traversing the tree, from its root to its leaves, or in other words starting upstream and moving downstream: whenever a node in the tree has an identical global signature in two replications of the catalogue this means that this node and all the “child” data elements of this node are identical, such that it is redundant to explore further the tree structure defined below this node.

In this same step, software and hardware module 14ⱼ constitutes a first list of descriptive data elements containing the values and versions of the descriptive data elements the version of which it possesses is more recent than that of software and hardware module 14ᵢ. It may also constitute a second list of descriptive data elements containing identifiers of the descriptive data elements the version of which it possesses is less recent than that of software and hardware module 14ᵢ. It then sends both these lists to software and hardware module 14ᵢ.

In a step 308, software and hardware module 14ᵢ processes the first list so as to update the descriptive data elements concerned in its replication of the catalogue.

In a step 310, it sends to software and hardware module 14ⱼ the values and versions of the descriptive data elements identified in the second list.

Subsequently, in a step 312, software and hardware module 14ⱼ processes these values and versions of descriptive data elements identified in the second list so as to update the descriptive data elements concerned in its replication of the catalogue. Whenever it processes an update of a descriptive data element it sends a synchronisation message, in accordance with the method described in reference to FIG. 3, to the software and hardware modules containing a replication of this descriptive data element, except for software and hardware module 14ᵢ.

Following this catalogue update between software and hardware module 14ⱼ and software and hardware module 14ᵢ, the fixed representation of the content of the catalogue is deactivated on the side of software and hardware module 14ⱼ in a step 314 and software and hardware module 14ᵢ is informed of this in a step 316.

Thus, in the final respective steps 318 and 320, software and hardware modules 14ᵢ and 14ⱼ are released in order that they may process, if applicable, the synchronisation messages received in their respective waiting lists throughout the duration of steps 306 to 316, so as to work through and delete these waiting lists, and subsequently to put themselves in a situation of reproducing the synchronisation steps as described in reference to FIGS. 3 and 4 when the situation occurs.

Steps 300 to 318 are repeated as many times as required on software and hardware module 14ᵢ for the update of all its catalogues of descriptive data elements.

It clearly appears that a method and/or system as described above allows the synchronisation of an IT system distributed across several servers for the supply of a service, such that each server in the system, and more specifically each software and hardware module acting on a server for the supply of the service, can play a role similar to the others and compensate for a fault.

1-10. (canceled)

11. A method for synchronizing software modules of an IT system distributed across plural servers interconnected as a network, each software module being executed on a server of the IT system for management of a set of data elements describing a service, in which at least a part of the descriptive data is replicated on multiple software modules, the method comprising:
at each execution, on any one of the software modules, as a first software module, of an action acting on a descriptive data element managed by the first software module, performing the following:
transmission by the first software module of a synchronization message identifying the action to all the other software modules of the IT system including a replication of this descriptive data element,
on receipt of this message by any of the software modules concerned, as a second software module, execution of the identified action on this second software module so as to act on the replication of the descriptive data element located on this second software module.

12. A method for synchronizing software modules according to claim 11, wherein execution of the action on the first software module causes an update of a version index and of a signature of the descriptive data element concerned, and execution of the action on any of the software modules including a replication of this descriptive data element causes the same update of version index and of signature of the replication of the descriptive data element concerned.

13. A method for synchronizing software modules according to claim 12, wherein the update of the signature of the descriptive data element concerned is incremental and commutative.

14. A method for synchronizing software modules according to claim 13, wherein the signature increment is a result of a random data generation.

15. A method for synchronizing software modules according to claim 12, wherein the set of descriptive data elements includes a tree structure in which each descriptive data element is either a node comprising at least one child element, or a terminating leaf, each node in the tree structure is associated with a global signature corresponding to a sum of signatures of the descriptive data elements located downstream from this node in the tree structure.

16. A method for synchronizing software modules according to claim 11, further comprising:
during bringing into operation of a software module including a part of the descriptive data elements, extraction of a state of the replications of this part of the descriptive data elements on at least one other software module, and saving the software module as a potential receiver of at least one synchronization message identifying an action on at least one replication of its descriptive data elements located on another software module;
synchronization of the descriptive data elements of the software module with the descriptive data elements of the other software module and, during this synchronization, queuing of any synchronization messages which may be received;
when the synchronization has terminated, the queue is processed.

17. Application of a method of synchronization of software modules according to claim 11, to an IT system distributed across plural servers interconnected as a network for supply of a data storage service distributed between storage peripherals each linked to a server in the IT system.

18. Application of a method of synchronization of software modules according to claim 17, wherein the descriptive data elements include at least one of elements of a set of data describing general infrastructure and general operation of the IT system, of data describing users of a data storage service and access rights, of data describing a structure or method of storage and replication of the stored data, and of data describing local infrastructure and local operation of a server or software module of the IT system.

19. A non-transitory computer readable medium including computer executable instructions executable by a processor, the computer executable instructions for execution of a method for synchronizing software modules of an IT system distributed across plural servers interconnected as a network according to claim 11 when the computer executable instructions are executed on a computer.

20. A system for synchronizing software modules of an IT system, comprising:
plural servers interconnected as a network, each software module being executed on a server of the IT system for the management of a set of data elements describing a service, in which at least a part of the descriptive data is replicated on multiple software modules,
each software module managing descriptive data elements and comprising:
means for transmitting a synchronization message, identifying an action acting on a descriptive data element, to all the other software modules in the IT system including a replication of this descriptive data element, whenever such an action is executed on this software module, and
means for executing an action acting on a descriptive data element and identified in a synchronization message, so as to act on the replication of the descriptive data element located on this software module, in response to the reception by this software module of the synchronization message.
